(19) United States
(12) Patent Application Publication
(10) Pub. No.: US 2022/0027949 A1
(43) Pub. Date: Jan. 27, 2022

(54) METHOD FOR OPERATING A DISPLAY SYSTEM HAVING A DISPLAY APPARATUS BY TAKING INTO CONSIDERATION A PROFILE OF INTERESTS OF A USER, AND DISPLAY SYSTEM

(71) Applicant: AUDI AG, Ingolstadt (DE)

(72) Inventors: Jacques HELOT, Ingolstadt (DE); Doreen ENGELHARDT, Ingolstadt (DE); Lars ELLERMANN, Ingolstadt (DE); Sven MICHAELIS, Ingolstadt (DE); Franz FUCHS, Manching (DE)

(73) Assignee: AUDI AG, Ingolstadt (DE)

(21) Appl. No.: 17/298,429

(22) PCT Filed: Nov. 25, 2019
(86) PCT No.: PCT/EP2019/082421

§ 371 Date: May 28, 2021

(51) Int. Cl. G06Q 30/02; H04W 4/029

(52) U.S. Cl. CPC G06Q 30/0266; G06Q 30/0269; H04W 4/029

(57) ABSTRACT

A motor vehicle has a display system with a display apparatus arranged on an outer side of the motor vehicle in a manner in which it can be viewed by a user outside the motor vehicle. An item of optical information is displayed on the display apparatus having content that is determined by an electronic computing device of the display apparatus by virtue of communication with the display apparatus using a mobile terminal. The mobile terminal is used to create an interest profile which characterizes the user on the basis of use of the mobile terminal and the interest profile is transmitted to the electronic computing device, so that the optical information can be determined for the user on the basis of the interest profile of the user for display on the display apparatus.

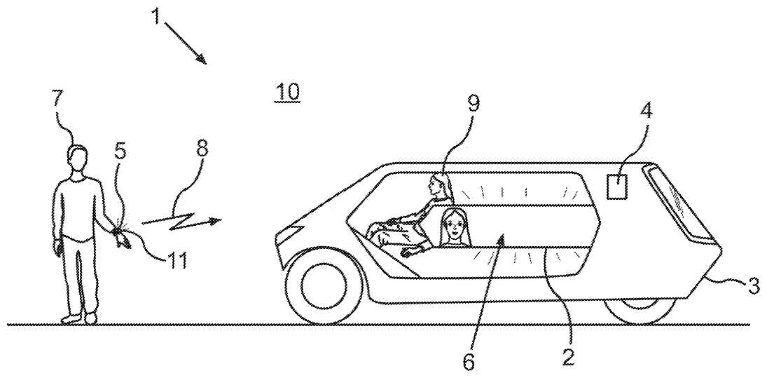

### CROSS REFERENCE TO RELATED APPLICATIONS

This application is a U.S. national stage of International Application No. PCT/EP2019/082421, filed on Nov. 25, 2019. The International Application claims the priority benefit of German Application No. 10 2018 220 691.0 filed on Nov. 30, 2018. Both the International Application and the German Application are incorporated by reference herein in their entirety.

### BACKGROUND

Described below is a method for operating a display system of a motor vehicle. The display system has a display apparatus, and the display apparatus is arranged on an outer side of the motor vehicle and in a manner which can be viewed by a user outside the motor vehicle. An item of optical information is displayed on the display apparatus, and the content of the optical information is determined by an electronic computing device of the display apparatus by virtue of communication with the display apparatus using a mobile terminal. Also described is such a display system.

The related art has methods in which display apparatuses arranged on an outer side of a motor vehicle can be operated. These display apparatuses can then in turn be viewed by all persons outside the motor vehicle.

For example, DE 10 2016 000 765 A1 discloses a vehicle having an advertisement device. The vehicle has a position detection unit for detecting a position of the vehicle and a communication unit for receiving advertising data from an external server unit. The advertisement device is designed to display advertising to another road user, wherein the displayed advertising depends on the position of the vehicle.

DE 10 2015 118 772 A1 also discloses a reconfigurable messaging assembly for a vehicle, including a bistable display with a low energy consumption which is fastened to the vehicle in order to display an image, text or a video. A processor and a storage device are connected to the display. A communicator, which includes transceivers for Wi-Fi, Bluetooth and NFC, is connected to the display in order to communicate with the portable electronic device. An interface device, which includes a camera and a touchscreen which are both arranged on the vehicle, is likewise connected to the display and to the processor in order to interact with a primary user and a secondary user and in order to record the images, text and videos. The interface device is operatively connected to the communicator in order to interact with a primary user and a secondary user.

The disadvantage of the related art is, however, the fact that the persons outside the motor vehicle who are not interested in the display of the optical information on the display apparatus are nevertheless provided with a display of the optical information.

### SUMMARY

Described below are a method and a display system which can be used to provide an item of optical information for a user in an improved manner.

One aspect relates to a method for operating a display system of a motor vehicle, wherein the display system has a display apparatus, and the display apparatus is arranged on an outer side of the motor vehicle and in a manner which can be viewed by a user outside the motor vehicle, wherein an item of optical information is displayed on the display apparatus, and the content of the optical information is determined by an electronic computing device of the display apparatus by virtue of communication with the display apparatus using a mobile terminal.

Provision is made for the mobile terminal to be used to create an interest profile of the user, which characterizes the user, on the basis of use of the mobile terminal by the user, and for the interest profile to be transmitted to the electronic computing device, and for the optical information to be determined for the user on the basis of the interest profile of the user and to be displayed on the display apparatus.

This makes it possible for the optical information to be displayed on the display apparatus in a manner individually adapted to the user. This makes it possible to individually display an item of optical information for the user. This enables improved operation of the display apparatus.

Provision may be made for the mobile terminal to be used to create the characterizing interest profile on the basis of use of the mobile terminal. For example, use can be evaluated by purchases on the Internet using the mobile terminal and the corresponding interest profile can be created. If it turns out, for example, that the user likes to barbecue, an advertisement of products for barbecuing can be accordingly displayed to the user as optical information. In particular, the optical information is displayed to the user only when the user is in the environment the motor vehicle. In particular, the predetermined environment is determined by a distance to the motor vehicle. For example, provision may be made for only users with the corresponding interest profile in a radius of ten meters around the motor vehicle to be provided with a display of the optical information.

Provision may be made for the mobile terminal to automatically transmit the interest profile characterizing the user to the motor vehicle, in particular to the electronic computing device of the display apparatus. The interest profile can therefore be transmitted to the electronic computing device without active assistance of the user. As a result, the optical information can be displayed on the outer side of the motor vehicle, in particular on the display apparatus, in a simple and nevertheless reliable manner. In particular, a basic permission from the user to be provided with a display of the optical information and to create the interest profile is accordingly given in advance.

An image or a video can be considered to be optical information, for example. The optical information is, in particular, advertising.

In particular, provision may be made for the optical information, for example an image, to be adapted to the user on the basis of the interest profile. In other words, if an item of optical information is displayed by a supermarket chain for example, provision may be made for a predetermined product to be displayed on the display apparatus on the basis of the user's interest profile. For example, if the user is a barbecue fan, corresponding products for barbecuing can be displayed on the display apparatus belonging to the supermarket. If the user is a youth, for example, the optical information from the supermarket may relate to a video game. Therefore, the optical information can be displayed on the display apparatus of the motor vehicle in a manner individually adapted to the user.

For example, a person driving a vehicle, who may be an owner of the motor vehicle, for example, or else in shared vehicles, would like to show advertising or other information on the outer side of the motor vehicle. In the case of a car sharing CityCar for example, the owner of the motor vehicle can send the content he wishes to show, for example an image or a video, to the vehicle. This content is shown when stationary and, when legally permitted, this can likewise be carried out during the journey of the motor vehicle. Furthermore, the occupant or customer of a taxi, for example, can provide a corresponding item of optical information for display.

Providing an item of optical information adapted to the user makes it possible to increase the advertising hit rate for the user since this is individually adapted to the user.

Provision may be made for the users of the mobile terminal to be made aware of when the motor vehicle provides an item of optical information of interest to the users. For example, a signal for vibrating the mobile terminal can be generated by the mobile terminal for this purpose. A corresponding vibration signal can be transmitted from the electronic computing device to the mobile terminal for this purpose. Furthermore, an automated call to the mobile terminal can be made, in which case the user can then be notified by the call where the relevant display apparatus is situated, for example to the left or right of the user.

Provision may be made for a mobile network, for example a GSM or UMTS network, to be able to be used for communication between the mobile terminal and the electronic computing device. Furthermore, communication can also take place by a local area network, for example by Bluetooth or WLAN, between the mobile terminal and the electronic computing device.

Provision may be made for a multiplicity of different items of optical information to be able to be displayed on the display apparatus, wherein the electronic computing device decides, on the basis of the received interest profile, which optical information from the multiplicity of items of optical information is selected and displayed.

In particular, provision may be made for a purchase behavior of the user and/or a hobby and/or a musical taste of the user to be evaluated in order to generate the interest profile. In particular, the interest profile is a profile of the user which is generated on the basis of actions which are carried out in the past and characterize the user, which profile can be used to determine a future behavior or a future purchasing interest of the user. For example, the interest profile can be taken as a basis for determining that the user likes to go to concerts and also which concerts the user likes to go to. A corresponding item of optical information relating to a future concert for the user can be displayed on the basis thereof.

According to one advantageous form of configuration, a content of the optical information is compared with the interest profile using the electronic computing device, and the optical information on the display apparatus is hidden if the interest profile does not correspond to the content. In other words, the content of the optical information can be hidden using the electronic computing device. In particular, the interest profile is then compared with the content of the optical information. If there is no correspondence, the optical information is prevented from being able to be displayed to the user. The information can therefore be displayed to or hidden from the user on an individual basis. If it is determined, for example, that the user is a vegan and the optical information relates to products for barbecuing, the comparison makes it possible to prevent the optical information relating to the products for barbecuing being displayed to the vegan. As a result, an item of optical information which is individually adapted to the user can be provided. In other words, the optical information is only visible to the user if the interest profile also corresponds to the corresponding optical information.

It has also proved to be advantageous if an item of neutral optical information which is independent of the interest profile is displayed if there is no correspondence. An item of neutral optical information may be, for example, a presentation of a single color which does not contain any actual optical information. For example, as optical information on the display apparatus, the display apparatus can then be controlled in such a manner that the display apparatus presents the color of the motor vehicle. In other words, an item of neutral optical information is displayed on the basis of the interest profile. In particular, this makes it possible for the optical information to not be displayed to the user who does not wish to have any optical information.

It has also proved to be advantageous if a multiplicity of interest profiles of a multiplicity of users, who can view the display apparatus, are transmitted from respective mobile terminals belonging to the users to the electronic computing device, and the optical information is displayed on the display apparatus on the basis of the multiplicity of interest profiles. In other words, a multiplicity of interest profiles can be received by the electronic computing device. In particular, it is possible for the multiplicity of interest profiles to then be evaluated by the electronic computing device. In particular, it is then possible to determine which optical information corresponds to all interest profiles. In particular, it is then precisely this optical information that corresponds to all interest profiles which is displayed on the display apparatus. It is likewise possible that, for example, a threshold value must be exceeded in order to display the optical information. For this purpose for example, provision may be made for the optical information to be displayed if there is a correspondence of 60% between the multiplicity of interest profiles and the optical information. As a result, the optical information can also be individually displayed on the motor vehicle for a multiplicity of users.

It is likewise advantageous if a static algorithm of the electronic computing device is used to determine which content is shown by the optical information. In particular, as a result, it is possible for the electronic computing device to accordingly statistically evaluate the interest profiles. In particular, the optical information is displayed only when a threshold value is exceeded during evaluation by the statistical algorithm. For example, provision may be made for the interest profile to have to have a correspondence of at least 60% with the content of the optical information, such that the optical information is displayed. As a result, the optical information can be displayed on the display apparatus in a simple and nevertheless reliable manner.

According to a further advantageous form of configuration, the optical information is additionally determined and/or displayed on the basis of a user of the motor vehicle who is inside the motor vehicle. The user of the motor vehicle may be a driver of the motor vehicle or an occupant of the motor vehicle. In particular, the optical information can be displayed only when the user would like to have the optical information displayed. In other words, the optical information is displayed on the display apparatus on the basis of the user's interest profile and on the basis of the user of the motor vehicle. Furthermore, the occupant can provide a multiplicity of items of optical information, and an item of optical information can be selected from the multiplicity of items of optical information from the occupant on the basis of the interest profile by the electronic computing device. For example, the user of the motor vehicle can determine the optical display and therefore the display of the optical information by switching the display apparatus on and off.

It has also proved to be advantageous if the optical information is displayed on the display apparatus only when it is determined that at least one user having an interest profile is in a predetermined environment of the motor vehicle. In other words, the optical information is displayed only when a user having a corresponding mobile terminal is in the predetermined environment, in other words in the vicinity, of the motor vehicle and a corresponding interest profile of the user has been created by the mobile terminal. This makes it possible to prevent the optical information from being unnecessarily displayed on the display apparatus even though a user having an interest profile is not in the vicinity. In particular, this makes it possible to save electrical energy in the motor vehicle. Furthermore, users without a corresponding mobile terminal cannot be provided with a display of the optical information.

It has also proved to be advantageous if a position detection device of the mobile terminal is used to detect a position of the user, and the position is taken as a basis for deciding whether the user is in the predetermined environment. For example, the mobile terminal may have a position detection device which can be used to reliably detect the position of the user. This position detection device can also be referred to as a global positioning system (GPS) or generally as a satellite-based positioning system. In particular, this makes it possible to reliably determine whether the user is in the predetermined environment, for example in a radius of ten meters around the motor vehicle, as a result of which the optical information is only then displayed. This makes it possible to save electrical energy since the optical information is also displayed on the display apparatus only when a user is in the environment of the motor vehicle.

In a further advantageous form of configuration, the mobile terminal is provided as a smartphone and/or as a smartwatch. In particular, the smartphone and the smartwatch are already widespread mobile terminals. In particular, a user can therefore already be characterized by the interest profile without purchasing a further mobile terminal. As a result, the method can be carried out in a simple and nevertheless reliable manner.

A further aspect relates to a display system for displaying an item of optical information on a display apparatus of a motor vehicle. The display system has at least the display apparatus with an electronic computing device and a mobile terminal which communicates with the electronic computing device, wherein the display system is designed to carry out a method according to the preceding aspect. In particular, the method is carried out by the display system.

Advantageous forms of configuration of the method can be considered to be advantageous forms of configuration of the display system. In this respect, the display system has concrete features which make it possible to carry out the method or an advantageous form of configuration of the latter.

### BRIEF DESCRIPTION OF THE DRAWINGS

These and other aspects and advantages will become more apparent and more readily appreciated from the following description of the exemplary embodiment, taken in conjunction with the accompanying drawing of which:

The sole drawing is a schematic perspective view of an embodiment of a display system.

### DETAILED DESCRIPTION

The exemplary embodiment is explained below in which the described components of the embodiment are each individual features which should be considered independently of one another. Therefore, the disclosure is also intended to include combinations other than the described combinations of the features of the embodiment. Furthermore, the described embodiment can also be supplemented with further features which have already been described.

In the FIGURE, identical reference signs each denote functionally identical elements.

The drawing is a schematic perspective view of an embodiment of a display system 1. The display system 1 has a display apparatus 2 which is arranged on a motor vehicle 3. The display apparatus 2 is arranged on an outer side of the motor vehicle 3. The display system 1 also has an electronic computing device 4 which may be formed as part of the display apparatus 2, in particular. The display system 1 also has a mobile terminal 5.

In the method for operating the display system 1 having the display apparatus 2 of the motor vehicle 3, an item of optical information 6 is displayed on the display apparatus 2 which is on the outer side of the motor vehicle 3 and can be viewed by a user 7 outside the motor vehicle, wherein the content of the optical information 6 is determined by the electronic computing device 4 of the display apparatus 2 by virtue of communication with the display apparatus 2 using the mobile terminal 5 belonging to the user 7.

Provision is made for the mobile terminal 5 to be used to create an interest profile 8 of the user 7, which characterizes the user 7, on the basis of use of the mobile terminal 5 by the user 7, and for the interest profile 8 to be transmitted to the electronic computing device 4, and for the optical information 6 to be determined for the user 7 on the basis of the interest profile 8 of the user 7 and to be displayed on the display apparatus 2.

Furthermore, provision may be made, in particular, for the content of the optical information 6 to be compared with the interest profile 8 using the electronic computing device 4, and for the optical content on the display apparatus 2 to be hidden if the interest profile 8 does not correspond to the optical content. Furthermore, provision may be made for an item of neutral optical information 6 which is independent of the interest profile 8 to be displayed if there is no correspondence.

Furthermore, provision may also be made for a multiplicity of interest profiles 8 of a multiplicity of the users 7, who can view the display apparatus 2, to be transmitted from respective mobile terminals 5 belonging to the users 7 to the electronic computing device 4, and for the optical information 6 to be displayed on the display apparatus 2 on the basis of the multiplicity of interest profiles 8.

Provision may likewise be made, in particular, for a statistical algorithm of the electronic computing device 4 to be used to determine which content is shown by the optical information 6. Provision may also be made for the optical information 6 to be additionally determined and/or displayed on the basis of a user 9 of the motor vehicle 3 who is inside the motor vehicle. The user 9 of the motor vehicle 3 may be a driver of the motor vehicle 3 or an occupant of the motor vehicle 3. In particular, the optical information 6 can be displayed only when the user 9 wishes to have the optical information 6 displayed. In other words, the optical information 6 is displayed on the display apparatus 2 on the basis of the interest profile 8 of the user 7 and on the basis of the user 9 of the motor vehicle 3. Furthermore, the occupant or user 9 can provide a multiplicity of items of optical information 6, and an item of optical information 6 can be selected from the multiplicity of items of optical information 6 from the occupant on the basis of the interest profile 8 by the electronic computing device 4. For example, the user of the motor vehicle 3 can determine the optical display and therefore the display of the optical information 6 by switching the display apparatus 2 on and off.

In particular, provision may be made for the optical information 6 to be displayed on the display apparatus 2 only when it is determined that at least one user 7 having the interest profile 8 is in a predetermined environment 10 of the motor vehicle 3. In other words, the optical information 6 is displayed only when a user 7 having a corresponding mobile terminal 5 is in the predetermined environment 10, in other words in the vicinity, of the motor vehicle 3 and a corresponding interest profile 8 of the user 7 has been created by the mobile terminal 5. This makes it possible to prevent the optical information 6 from being unnecessarily displayed on the display apparatus 2 even though a user 7 having an interest profile 8 is not in the vicinity. In particular, this makes it possible to save electrical energy in the motor vehicle 3. Furthermore, users 7 without a corresponding mobile terminal 5 cannot be provided with a display of the optical information 6.

Furthermore, provision may be made for a position detection device 11 of the mobile terminal 5 to be used to detect a position of the user 7, and for the position to be taken as a basis for deciding whether the user 7 is in the predetermined environment 10.

In particular, provision is made for the mobile terminal 5 to be provided as a smartphone and/or as a smartwatch.

A user 9 driving a motor vehicle 3 would like to show advertising or other information as optical information 6 on the outer side of the motor vehicle 3. In the case of a “car sharing CityCar” for example, the user 9 can send the content which the user 9 wishes to show, for example as an image or video, to the motor vehicle 3. This content is displayed when the motor vehicle 3 is stationary and, when legally permitted, is likewise displayed during the journey of the motor vehicle 3.

In addition, the optical information 6 can be displayed only when the user 7 or the multiplicity of users 7 in the vicinity has/have an interest profile 8 on their cellphone or smartwatch corresponds to the content of the optical information 6 be displayed on the motor vehicle 3. If it is determined, for example, that the interest profile 8 does not correspond, the display can be switched off or can be changed over to something neutral. For example, if there are many users 7 in the environment 10, provision may be made for a statistical algorithm to decide whether and, in particular, which optical information 6 is displayed.

In a further advantageous form of configuration, the optical information 6 can always be shown, but can be adapted in such a manner that it best corresponds to the characterizing interest profile 8 of the user 7.

For example, according to the drawing, provision may be made for the optical information 6 to be displayed if the interest profile 8 matches, that is to say if a comparison between the interest profile 8 and the optical information 6 has taken place by the electronic computing device 4. If the optical information 6 does not match the interest profile 8, the display apparatus 2 can display or hide an item of neutral optical information 6.

In particular, the display apparatus 2 can be controlled with respect to the outside and can be made visible/invisible by the user 9, depending on the interest profile 8 of the users 7.

In particular, this makes it possible for the user 9 or the occupant of the motor vehicle 3 to have the opportunity to communicate to the outside. In particular, the optical information 6 is visible only when the user 7 also so wishes or when the user 7 has an interest in this. The user 7 can additionally be warned, for example, via the mobile terminal 5, when an item of optical information 6 of interest to the user 7 is displayed on the display apparatus 2 of the motor vehicle 3. In contrast, the user 7 whose interest profile 8 does not correspond to the optical information 6 accordingly cannot be provided with the optical information 6.

Overall, the system shows a display on a display on an outer side of a motor vehicle 3, which display can be controlled and can be made visible/invisible by a user 9.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (cancelled)

11. A method for operating a display system of a motor vehicle, the display system including a display apparatus arranged on an outer side of the motor vehicle viewable by a user outside the motor vehicle, comprising:
displaying an item of optical information on the display apparatus;
determining content of the optical information by an electronic computing device of the display apparatus by virtue of communication with the display apparatus using a mobile terminal belonging to the user;
creating, by the mobile terminal, an interest profile of the user characterizing the user, based on use of the mobile terminal by the user; and
transmitting the interest profile to the electronic computing device, so that the determining of the optical information is based on the interest profile of the user prior to the displaying on the display apparatus.

12. The method according to claim 11, further comprising:
comparing the content of the optical information with the interest profile using the electronic computing device; and
hiding the optical information on the display apparatus when the interest profile does not correspond to the optical content.

13. The method according to claim 12, wherein said displaying displays an item of neutral optical information independent of the interest profile when no correspondence is found by the comparing.

14. The method according to claim 13,
wherein said transmitting transmits a multiplicity of interest profiles of a multiplicity of users, within view of the display apparatus, from respective mobile terminals belonging to the users to the electronic computing device, and
wherein said displaying displays the optical information on the display apparatus based on the multiplicity of interest profiles.

15. The method according to claim 14, wherein a statistical algorithm of the electronic computing device determines the content of the optical information in said determining.

16. The method according to claim 15, wherein said determining of the optical information is further based on an occupant of the motor vehicle inside the motor vehicle.

17. The method according to claim 16,
further comprising making a determination when the optical information is matches at least one interest profile of at least one user in a predetermined environment relative to the motor vehicle, and
wherein said displaying is performed only when the determination is made.

18. The method according to claim 17,
further comprising receiving a position of the user detected by a position detection device in the mobile terminal, and
wherein said making of the determination is based on the position of the user in deciding whether the user is in the predetermined environment.

19. The method according to claim 18, wherein the mobile terminal is one of a smartphone and a smartwatch.

20. The method according to claim 11,
wherein said transmitting transmits a multiplicity of interest profiles of a multiplicity of users, within view of the display apparatus, from respective mobile terminals belonging to the users to the electronic computing device, and
wherein said displaying displays the optical information on the display apparatus based on the multiplicity of interest profiles.

21. The method according to claim 11, wherein said determining of the optical information is further based on an occupant of the motor vehicle inside the motor vehicle.

22. The method according to claim 11,
further comprising making a determination when the optical information is matches at least one interest profile of at least one user in a predetermined environment relative to the motor vehicle, and
wherein said displaying is performed only when the determination is made.

23. The method according to claim 22,
further comprising receiving a position of the user detected by a position detection device in the mobile terminal, and
wherein said making of the determination is based on the position of the user in deciding whether the user is in the predetermined environment.

24. A display system for displaying an item of optical information outside of a motor vehicle to a user carrying a mobile terminal, comprising:
a display apparatus; and
an electronic computing device configured to
communicate with the mobile terminal, to receive an interest profile of the user characterizing the user based on an operational history of the mobile terminal by the user,
determine the item of the optical information based on the interest profile of the user, and
control the display apparatus to display the item of the optical information to the user.

25. The display system according to claim 24, wherein the electronic computing device is further configured to
compare the content of the optical information with the interest profile, and
hide the optical information on the display apparatus when the interest profile does not correspond to the optical content.

26. The display system according to claim 24, wherein the electronic computing device is further configured to control the display apparatus to display an item of neutral optical information independent of the interest profile when no correspondence is found between the interest profile of the user and the optical information directed to interests.

27. The display system according to claim 24,
wherein the electronic computing device receives a multiplicity of interest profiles of a multiplicity of users, within view of the display apparatus, from respective mobile terminals belonging to the users, and
wherein the electronic computing device is further configured to control the display apparatus to display the optical information on the display apparatus based on the multiplicity of interest profiles.

28. The display system according to claim 24, wherein the electronic computing device is further configured to determine the item of the optical information based on an occupant of the motor vehicle.

29. The display system according to claim 24, wherein the electronic computing device is further configured to
make a determination when the optical information is matches at least one interest profile of at least one user in a predetermined environment relative to the motor vehicle, and
control the display apparatus to display the item of the optical information only when the determination is made.

30. The display system according to claim 29, wherein the electronic computing device is further configured to
receive a position of the user detected by a position detection device in the mobile terminal, and
make the determination based on the position of the user in deciding whether the user is in the predetermined environment.
